(19) United States
(12) Patent Application Publication
(10) Pub. No.: US 2003/0162553 A1
(43) Pub. Date: Aug. 28, 2003

(54) Wireless paging based at least partially on the technological capability of the mobile device

(76) Inventors: Ching Yao Huang, Randolph, NJ (US); Philip A. Kotek, Naperville, IL (US); David Albert Rossetti, Randolph, NJ (US); Terry Alan Stevens, Batavia, IL (US)

Correspondence Address: GARDNER GROFF, P.C., PAPER MILL VILLAGE, BUILDING 23, 600 VILLAGE TRACE, SUITE 300, MARIETTA, GA, 30067, US

(21) Appl. No.: 10/086,910

(22) Filed: Feb. 28, 2002

(51) Int. Cl. H04Q 7/20

(52) U.S. Cl. 455/458; 455/459

(57) ABSTRACT

An apparatus that generates wireless paging requests that are based at least in part on the technological capability of the mobile device to be paged. The apparatus comprises processing circuitry that is capable of generating paging request that are based at least partially on knowledge that the apparatus is capable of accessing relating to one or more technological capabilities of mobile devices. The processing circuitry is in communication with, or comprised by, the wireless network. When the wireless network broadcasts a paging request for a particular mobile device, the paging request preferably is only broadcast to cells that have the same technological capability of the mobile device being paged. By paging based at least in part on the technological capability of the mobile device, the number of pages issued can be greatly reduced, which reduces paging overhead and provides other advantages.

### TECHNICAL FIELD OF THE INVENTION

The present invention relates to wireless communications and, more particularly, to paging in a wireless network in a manner that can reduce paging overhead of the network. The term paging, as that term is used herein, is intended to denote the method of locating an mobile device within a wireless network, such as for the purpose of terminating a voice call, for example.

### BACKGROUND OF THE INVENTION

Wireless networks allow users to use mobile devices, such as cellular telephones and personal digital assistants (PDAs), for example, to communicate over a wireless link with cells, also commonly referred to as base stations. Each cell is in communication with a mobile switching center (MSC) via a wired link, such as a T1 line, for example, or via a wireless link, such as a microwave frequency link, for example. The mobile devices communicate with the cell, which, in turn, communicates with the MSC. The MSC establishes the communication link between the mobile user and the party that called the mobile user, or the party that was called by the mobile user.

Each MSC has a database known as a home location register (HLR) and a database known as visitor location register (VLR). The HLR is the main database of permanent subscriber information for a mobile network. The HLR is maintained by the subscriber's home carrier (or the network operator where the user initiated the call) and contains user information such as the user's residence address, account status, and certain preferences. The HLR interacts with the MSC, which performs the switching functions needed for call control and processing. The MSC also serves as a point-of-access to the Public Switched Telephone Network (PSTN) and other services, such as, for example, packet data (Internet), geolocation, or short messaging services. The VLR maintains temporary user information, such as the user's current location, to manage requests from subscribers who are out of the area covered by their home system.

When a mobile user initiates a call, a cell or cells in the area where the call was initiated, contacts the MSC with which the cell(s) communicates. The MSC switching equipment then determines whether or not the call is coming from the mobile device's home area. If the user is out of the home area, the area VLR causes the MSC handling the call to send out a request for information required to process the call. The serving MSC analyzes the HLR identified by the call, and then relays information to the appropriate MSC, which in turn updates the home VLR. The home MSC then sends routing information back to the serving MSC, which allows it to find the cell where the call originated, and ultimately, the mobile device that initiated the call.

For mobile-terminated services, in order to find the mobile device, the MSC sends out a paging request to sets of cells that are in communication with the MSC (and possibly to cells of adjacent MSCs). Because there are typically a large number of cells associated with each MSC, the MSC attempts to locate the mobile device by paging in a manner that reduces paging overhead. In other words, rather than paging each cell associated with the MSC, which would require a large amount of paging overhead, the MSC uses information it has available to it to reduce the number of cells paged to a subset of the total set of cells. Currently, this is typically accomplished by paging a subset of cells in the geographic region where the mobile device was last seen, which is information that is contained in the home MSC HLR. Once the MSC locates the cell serving the mobile device, the location of the mobile device is updated in the HLR of the home MSC. If the mobile device is not in the home area, a record is also created in the VLR of the out-of-area MSC to enable the roaming mobile device to be served by the out-of-area MSC.

Mobile devices are currently being developed that support multiple technologies, such as personal communications services (PCS), which operates in the 1,850-1990 megahertz (MHz) frequency bands, and cellular, which operates in the 806-902 MHz frequency bands. The PCS and cellular frequency bands are known as band classes. Cells and MSCs that handle PCS calls generally require equipment that is different from the equipment required by MSCs and cells that handle cellular calls and thus have been implemented as separate networks.

Mobile devices may also support different wireless standards (e.g., AMPS, TDMA, CDMA (IS95/IS2000), GSM, UMTS), and may support different paging technologies within these wireless standards (e.g., IS-2000 Paging Channel, Quick Paging Channel, Common Control Channel).

In accordance with the present invention, it has been determined that it would be desirable to have a single network that is capable of handling multiple types of technologies, such as PCS and cellular. In accordance with the present invention, it has been determined that the cells and MSCs of the different technologies can be integrated into a single network. Moreover, the different equipment required to handle the different technologies for the cells could be co-located, and even utilize the same antenna for communicating with mobiles. Likewise, the equipment for handling the different types of technologies at the MSC could be co-located. Thus, a single network could be implemented that handles multiple technologies, such as PCS and cellular, for example, in the same way that newly-developed mobile devices support multiple technologies. In such a network, paging solely on a geographical basis would not work well, if at all, for the following reasons. If, for example, an incoming call for a mobile device is received by such a network, and the network does not know whether the mobile device supports PCS, cellular or both, the network would be required to issue the same number of paging requests to both the PCS cells and to the cellular cells for a given geographic region. Therefore, paging overhead, or loading, in the network would actually be increased rather than decreased because paging requests would be needed for cells supporting each technology.

In accordance with the present invention it has been determined that in order for paging to be efficiently performed in a network that supports multiple technologies, the network would need to know something about the technological capabilities of the mobile device. For example, if the network had information that the mobile device supported only PCS, then the network could reduce paging overhead by only paging PCS cells, as opposed to paging both cellular and PCS cells. Currently, paging techniques do not take into account such band class information when generating paging requests. Accordingly, a need exists for a paging technique that takes into account the technological capabilities of the mobile device when generating paging requests, and for a network that can perform such a paging technique in a manner that reduces paging overhead.

### SUMMARY OF THE INVENTION

In accordance with the present invention, an apparatus is provided that generates wireless paging requests that are based at least in part on the technological capability of the mobile device to be paged. The apparatus comprises processing circuitry that is capable of generating paging request that are based at least partially on knowledge that the apparatus is capable of accessing relating to one or more technological capabilities of mobile devices.

The processing circuitry is in communication with, or comprised by, the wireless network. When the wireless network broadcasts a paging request for a particular mobile device, the paging request preferably is only broadcast to cells that have the same technological capability of the mobile device being paged. By paging based at least in part on the technological capability of the mobile device, the number of pages issued can be greatly reduced, which reduces paging overhead and provides other advantages.

In accordance with the preferred embodiment, paging requests are generated based on one or more technological capabilities of the particular mobile device being paged and at least in part on the registered zone the network knows the mobile device last communicated. Since mobile devices are currently being designed with multiple technological capabilities for communicating, paging only mobile devices that have the technological capability to respond to the page reduces paging overhead. By also basing paging on the last zone in which the mobile device registered, paging overhead can be even further reduced.

These and other features and embodiments of the present invention will be described below with reference to the detailed description, drawings and claims.

### BRIEF DESCRIPTION OF THE DRAWINGS

FIG. 1 illustrates a wireless network and the communications links between an MSC and a plurality of cells, which communicate wirelessly with mobile devices.

FIG. 2 illustrates a wireless network similar to the wireless network of FIG. 1, but which is capable of supporting multiple technologies in accordance with an example embodiment of the present invention.

FIG. 3 illustrates a wireless network in which cells that support different technologies share the same geographic region.

FIG. 4 illustrates a flow chart, which demonstrates an example embodiment of the paging method of the present invention.

FIG. 5 illustrates a flow chart, which demonstrates an example embodiment of the paging method of the present invention.

### DETAILED DESCRIPTION OF THE INVENTION

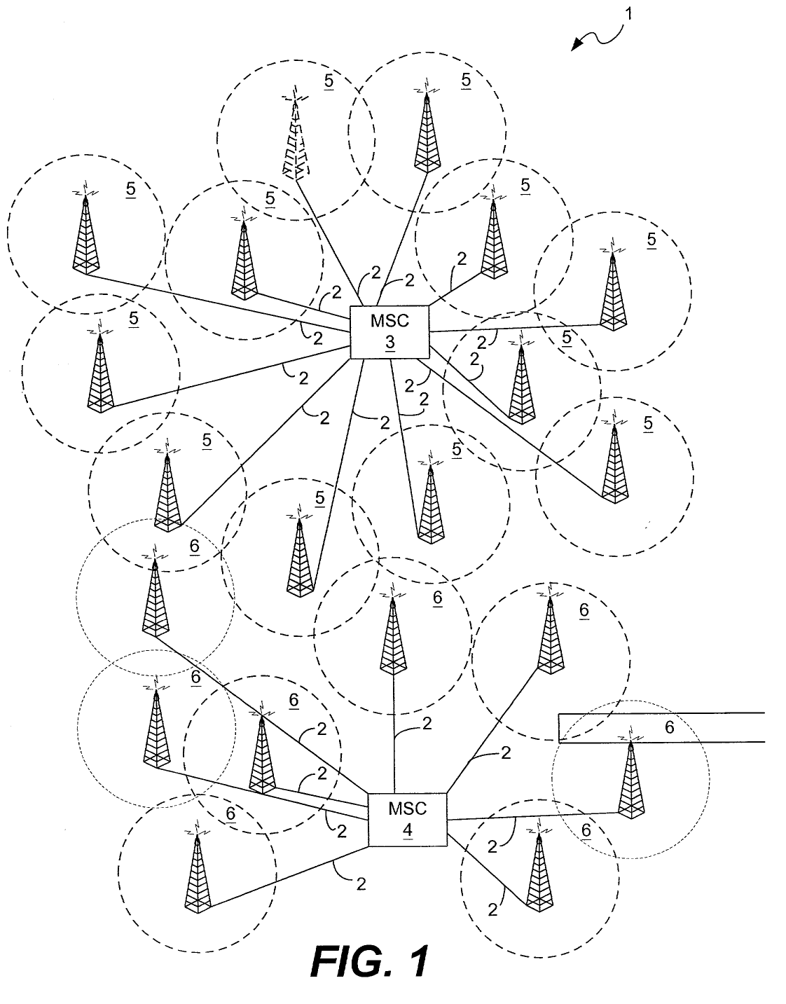

FIG. 1 illustrates a wireless network 1 and the communications links 2 between two MSCs 3 and 4 and a plurality of cells 5 and 6, respectively, which communicate wirelessly with mobile devices (not shown). In order to find a mobile device, one of the MSCs 3, 4 will send out a paging request to a subset of the cells 5, 6 that are in communication with whichever of the MSC 3, 4 that sends out the paging request. As stated above, in known wireless networks, this is typically accomplished by paging a subset of cells in the geographic region where the mobile device was last seen, which is information that is contained in the home MSC HLR and which can be transferred by the home MSC to an out-of-area MSC.

Specifically, known networks are partitioned into one or more geographical paging zones and require that the mobile device re-register with the network whenever the mobile device crosses a geographical cell boundary. This re-registration requirement enables the network to track the mobile device so that paging of the mobile device on a geographic basis can be performed more efficiently by first paging the geographic area identified in the re-registration information. Once the MSC locates the cell serving the mobile device, the location of the mobile device is updated in the HLR of the home MSC. If the mobile device is not in the home area, a record is also created in the VLR of the out-of-area MSC to enable the roaming mobile device to be served by the out-of-area MSC. When the mobile device moves out of the area served by an out-of-area MSC, the corresponding VLR record is deleted.

In accordance with the present invention, the wireless network has the configuration shown in FIG. 1, but performs paging based at least in part on information relating to a) the technological capabilities known to be supported by the mobile device and/or b) last seen technology used by the mobile station. For example, if a given mobile device supports both PCS and cellular technologies, a corresponding indication is recorded and remembered by the network The information may be recorded at the home area MSC. The information may be recorded in the form of an entry in the HLR or VLR of the home area MSC, or it may be recorded in a separate database at the home area MSC or at some other location in the network that is accessible by the home area MSC so that it can be used to generate paging requests. The paging requests may be issued by the home area MSC or by an out-of-area MSC that requests and receives the information from the home area MSC.

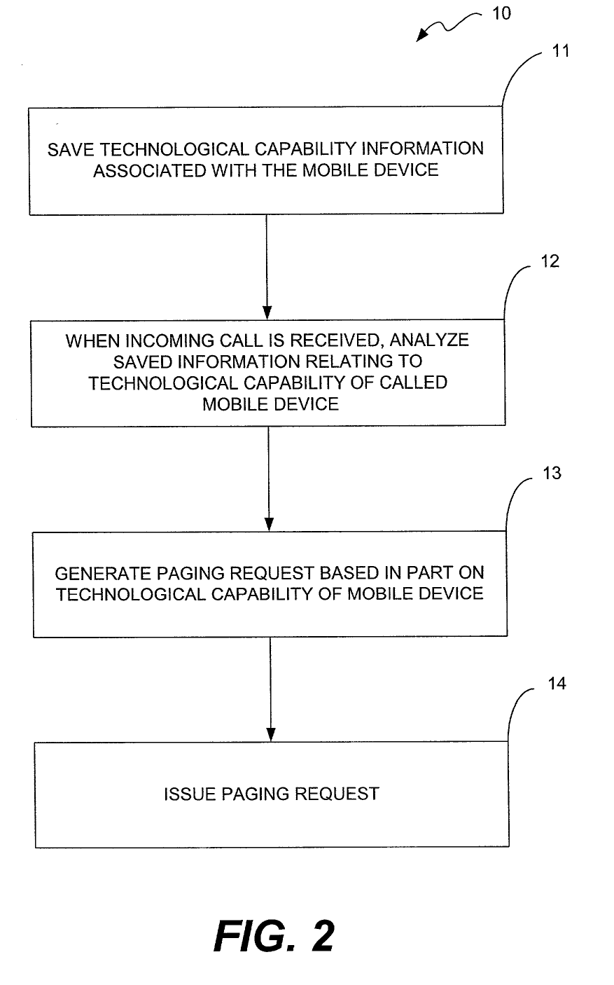

FIG. 2 illustrates a flow chart, which demonstrates an example embodiment of the paging method 20 of the present invention. As stated above, information relating to the technological capability of each mobile device is saved by the network, as indicated by block 11. This information may either be derived by requesting information from the mobile, determined automatically be observing mobile behavior, or by database provisioning. When an incoming call is received by an MSC, the MSC analyzes the information relating to the technological capability of the mobile device identified by the call to determine the technological capabilities of the mobile device, as indicated by block 12. The MSC then uses this information to generate a paging request, as indicated by block 13. As indicated above, the paging request may be generated by the home area MSC if the mobile device was last seen in the home area, or by an out-of-area MSC that receives the information needed to generate the paging request from the home MSC. The appropriate MSC then issues the paging request, as indicated by block 14. It should be noted that the mobile capabilities may be saved by the Home MSC and/or by the Serving MSC. In other words, the Home MSC could direct the serving MSC to page only a certain band class, or the Home MSC could request the serving MSC page the mobile, which would result in the serving MSC determining that it should only page a certain band class.

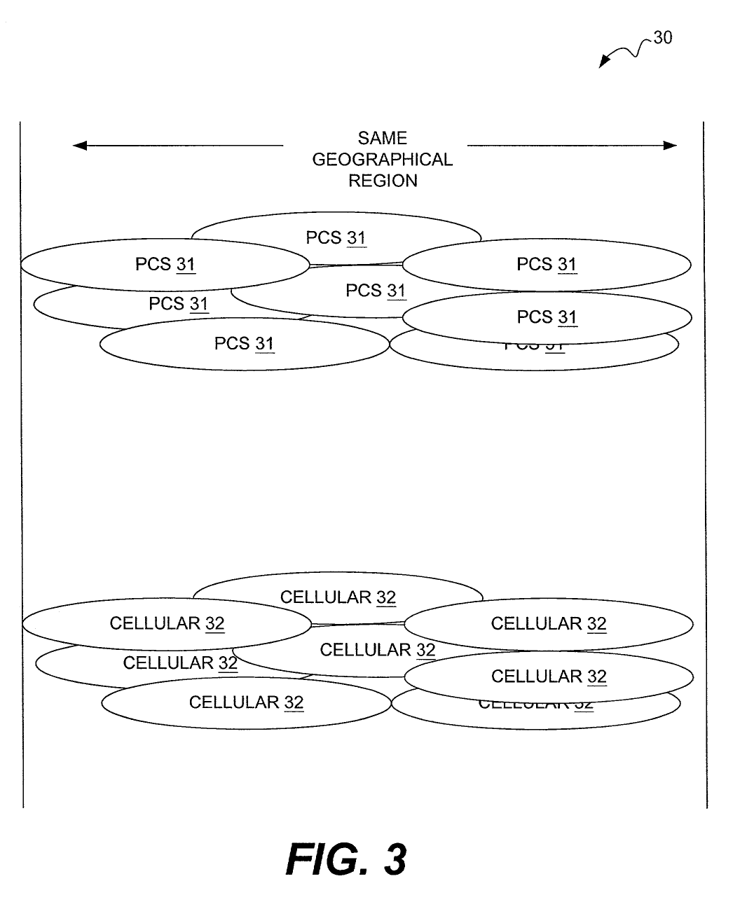

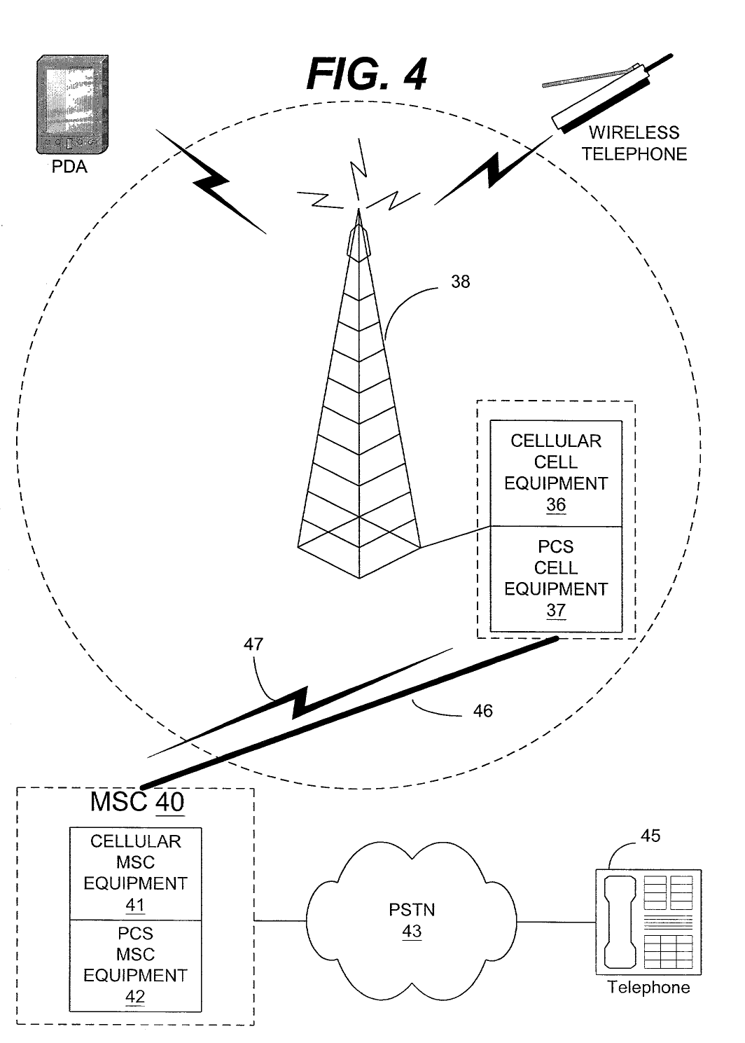

An example of the manner in which the present invention is capable of reducing paging overhead will now be described with reference to the diagrams of FIGS. 3 and 4. FIG. 3 illustrates a wireless network 30 in which cells that support different technologies share the same geographic region. In this example, the wireless network supports both PCS technology and cellular technology. Therefore, the network 30 is capable of handling calls in the PCS band class and in the cellular band class. The present invention is particularly useful in the case where the PCS cells of the network cover the same geographical area as the cellular cells because geographical paging will require a relatively large amount of paging overhead unless the network 30 knows whether to page subsets of the PCS cells 31 and/or subsets of the cellular cells 32. In accordance with the present invention, a determination can be made as to whether page PCS cells and/or cellular cells based on the information that the network has about the technological capabilities of the mobile device.

FIG. 4 illustrates a cell 35 of the wireless network of the present invention in accordance with an example embodiment in which the cellular and PCS cell equipment 36 and 37, respectively, are co-located and preferably use respective antennas that are co-located. Of course, it is not a requirement of the invention that the cells be co-located or that the antennas be co-located. The co-location of the cellular and PCS cell equipment 36 and 37, respectively, and of the antennas 38 is illustrated for the purpose of describing an example of a wireless network that supports multiple technologies and an example of one situation in which the paging method of the present invention is particularly useful at reducing paging overhead.

For this example, both the cellular MSC equipment 41 and the PCS MSC equipment 42 are also co-located at the same MSC 40, which is also not a requirement of the present invention, but is illustrated for the purpose of demonstrating integration of these different technologies into a single network. The MSC 40 also is in communication with the Public Switched Telephone Network (PSTN) 43 to enable the wireless network to interface with the PSTN. Therefore, calls made by a non-wireless telephone 45 connected by a landline to the PSTN 43 can be connected to a mobile device via the MSC 40 and the cell with which the mobile device is in communication. The MSC 40 may also be connected to other networks (not shown), such as, for example, those that support Packet Data services, Short Message services, Position Location services.

The MSC 40 is connected by a wired connection 46, such as a T1 line, or by a wireless link, such as a microwave wireless link 47 to the cellular cell equipment 36 and to the PSC cell equipment 37. The link between an MSC and cells is commonly referred to as the backhaul. The link 46 or 47 handles all information being communicated between the cell equipment and the MSC, such as voice and data associated with information sent back from a web server, in the case where the mobile device is capable of accessing the Internet. In addition, the link 46 or 47 also includes a channel for call setup and termination and a paging channel. Therefore, by reducing the paging overhead, or loading, the overall loading of the backhaul can be reduced. The “paging channel”, as that phrase is used herein is intended to denote any type of broadcast control channel used to facilitate locating a mobile device, including, but not exclusive to, a channel used for call setup and termination.

The advantages of reducing the backhaul loading include increased bandwidth of the backhaul and/or a reduction in the equipment needed to implement the backhaul. For example, the number of T1 lines in the wireless network could potentially be reduced by reducing paging overhead. Those skilled in the art will understand these and other advantages associated with reducing the backhaul loading and the manner in which the present invention enables this to be accomplished.

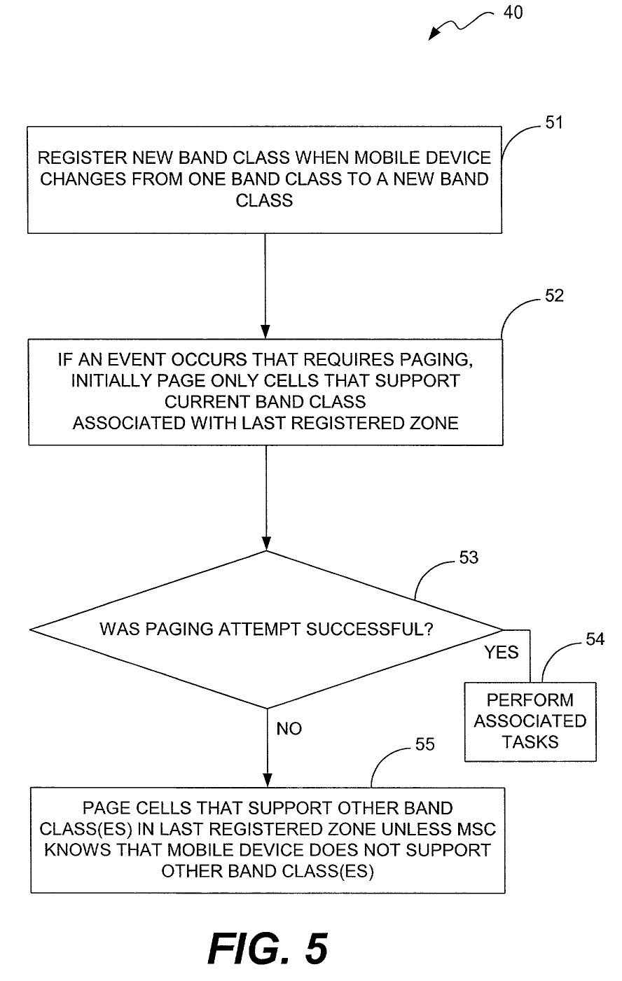

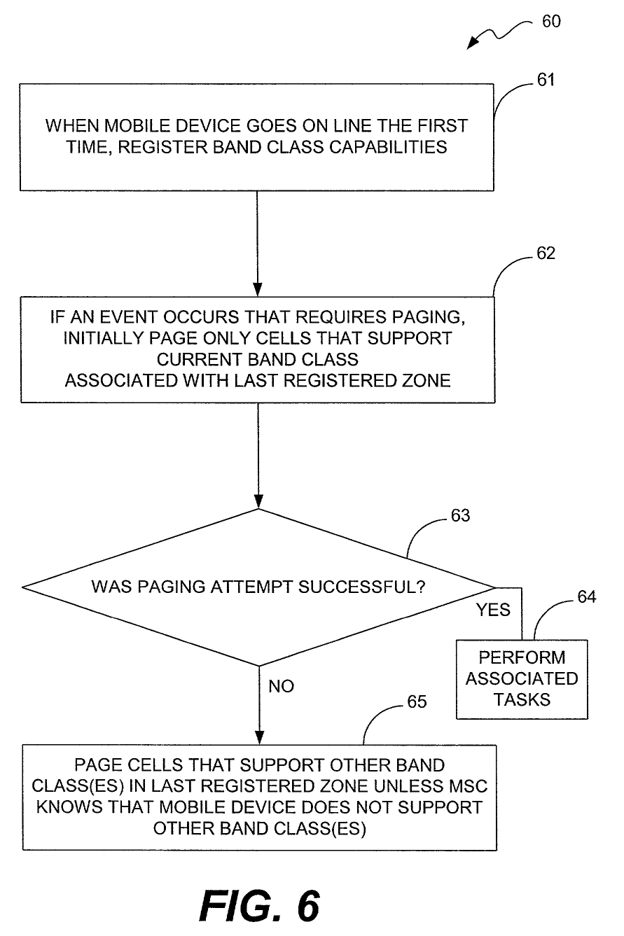

FIG. 5 illustrates a flow chart, which demonstrates an example embodiment of the paging method of the present invention. In accordance with this example embodiment the paging method 50, when ever a mobile device changes from one band class to another, the new band class is registered with the wireless network, as indicated by block 51. As stated above, the band class information may be saved at the home MSC in the HLR or VLR databases, or in the VLR of the serving MSC, or at some other suitable location in the network. Then, if an event occurs that requires paging of the mobile device, such as an incoming call for the mobile device or an attempt by the mobile device to terminate a call, the MSC will initially page only cells that support the most recently registered band class in the most recently registered zone, as indicated by block 52. As stated above, whenever a mobile device moves across a cell boundary, the cell that the mobile device moves into is registered with the network. This region served by the new cell corresponds to the most recently registered zone. Therefore, in accordance with this example embodiment, the MSC generates a paging request that is based on the most recently registered geographical zone as well as on the most recently registered band class.

If the paging attempt is successful, the mobile device performs the tasks corresponding to the purpose for the page, as indicated by block 54. If the paging attempt was not successful, then the cells that support a different band class that are within the last registered zone are paged, as indicated by block 55.

The reduction in paging overhead can be very significant. For example, if the network supports PCS and cellular and the network knows that the mobile device only supports PCS, the cellular cells need not be paged at all. Thus, assuming an MSC that is served by 100 PCS cells and 100 cellular cells, the MCS immediately knows that it can ignore at least half of the cells, which is a huge reduction in the potential number of cells that might need to be paged. Furthermore, when this knowledge is combined with other knowledge that the network has, such as the most recently registered zone of the mobile device, the potential number of cells that might need to be paged is even further reduced. Also, in view of the fact that mobile devices are beginning to be developed that support multiple technologies, and in view of the fact that people will likely continue to use mobile devices that only support a single technology, geographical paging without the knowledge of the technological capabilities of the mobile device will result in inefficient paging, and potentially increased paging overhead.

FIG. 6 illustrates the method 60 of the present invention in accordance with another example embodiment. The method described above with reference to FIG. 5 assumes that the mobile devices are capable of supporting multiple band classes. As indicated above, although some mobile devices being developed are capable of supporting multiple band classes, it is likely that many mobile devices will continue to be used that only support a particular band class. In this case, step 51 of FIG. 5 will not provide the network with knowledge about the capability of a mobile device that always uses the same band class. FIG. 6 illustrates a method wherein whenever a mobile device goes on line for the first time, it will register all of its band class capabilities with the network, as indicated by block 61. Therefore, regardless of whether the mobile device supports only one band class or a plurality of band classes, steps 62-65 of the flow chart of FIG. 6 will enable paging to be performed efficiently. Steps 62-65 of FIG. 6 are identical to steps 52-55, respectively, of FIG. 5.

It should be noted that the present invention has been described only with respect to example embodiments (e.g., band class capability of a network and mobile device band class capabilities). The present invention is equally applicable to mobile devices that support multiple technologies, such as GSM, TDMA, CDMA, for example. The present invention is also applicable to networks and mobile devices that utilize different protocol revisions for call processing, such as IS95B/IS2000). Likewise, the present invention is applicable to networks and mobile devices that utilize different physical/logical channels, such as, for example, Quick Paging Channel and Common Control Channel. Those skilled in the art will understand, in view of the discussion provided herein the manner in which the present invention can be broadly applied to reduce paging and to integrate different network technologies. It should also be noted that the present invention encompasses other types of capabilities of mobile devices and networks not explicitly mentioned herein, and that are known now or are developed in the future.

What is claimed is:

1. An apparatus for wirelessly paging a mobile device based at least in part on a technological capability of the mobile device, the apparatus comprising:
processing circuitry configured to access information associated with the technological capability of the mobile device and to generate a paging request for the mobile device that is based at least partially on the technological capability of the mobile device.

2. The apparatus of claim 1, wherein the paging request is based at least partially on an identifier associated with the mobile device to be paged.

3. The apparatus of claim 1, wherein the apparatus is in communication with a wireless network that comprises at least one cell, said at least one cell being configured to receive the paging request generated by the processing circuitry and to wirelessly broadcast the paging request via an antenna of the network to enable said at least one cell to wirelessly communicate with the mobile device being paged.

4. The apparatus of claim 3, wherein said technological capability includes a wireless protocol technology that said at least one cell utilizes to wirelessly broadcast paging requests to mobile devices that have the technological capability to wirelessly communicate using said wireless protocol technology.

5. The apparatus of claim 3, wherein said technological capability corresponds to a band class over which said at least one cell is configured to wirelessly broadcast paging requests and over which the mobile device being paged is configured to wirelessly communicate.

6. The apparatus of claim 3, wherein said technological capability corresponds to one or more specific channels over which the mobile device being paged is capable of communicating and over which said at least one cell is capable of communicating with mobile device.

7. The apparatus of claim 3, wherein the processing circuitry is comprised at a Mobile Switching Center (MSC) of the wireless network, and wherein the technological capability of the mobile device is stored at the MSC of the wireless network, the MSC being the home MSC of the mobile device.

8. The apparatus of claim 7, wherein the technological capability of the mobile device is stored in a Home Location Register (HLR) of the home MSC.

9. The apparatus of claim 7, wherein the technological capability of the mobile device is stored in a Visitor Location Register (VLR) of the home MSC.

10. The apparatus of claim 7, wherein when the mobile device is to be paged, the MSC generates a paging request that is broadcast only to mobile devices that have the same technological capability of the mobile device being paged.

11. The apparatus of claim 7, wherein the MSC is a serving MSC of the mobile device, and wherein the serving MSC determines when the mobile device has registered with the network comprising the serving MSC, and wherein the serving MSC obtains information relating to the technological capability of the mobile device from the home MSC of the mobile device, and wherein the serving MSC uses the information obtained by the MSC when generating a page request for the mobile device that is based at least partially on the information obtained from the home MSC relating to the technological capability of the mobile device.

12. The apparatus of claim 10, wherein the paging request that is broadcast to mobile devices having the same technological capability of the mobile device being paged is first broadcast in a last zone in which the mobile device being paged registered with the network, and wherein the home MSC accesses this registration information and includes the registration information in the page request when the page request is generated.

13. The wireless network of claim 10, wherein said technological capabilities of the mobile devices include a wireless protocol technology that said at least one cell utilizes to wirelessly page mobile devices that have the technological capability needed to wirelessly communicate with the cell that is paging the particular mobile device.

14. The wireless network of claim 10, wherein said multiple wireless technologies of the network correspond to multiple band classes over which said MSC and said at least one cell are configured to wirelessly broadcast paging requests and over at least one of which the particular mobile device being paged is configured to wirelessly communicate.

15. The wireless network of claim 10, wherein said multiple wireless technologies correspond to multiple specific channels over which the network can issue pages and over at least one of which the particular mobile device being paged is capable of communicating.

16. The wireless network of claim 10, wherein the technological capabilities of the mobile devices are stored in a Home Location Register (HLR).

17. The wireless network of claim 10, wherein the technological capabilities of the mobile devices are stored in a Visitor Location Register (VLR).

18. A method for wirelessly paging a mobile device based at least in part on a technological capability of the mobile device, the method comprising the steps of:
accessing information associated with the technological capability of the mobile device from processing circuitry in communication with a wireless network; and
generating a paging request for the mobile device that is based at least partially on the technological capability of the mobile device.

19. The method of claim 18, wherein the paging request is based at least partially on an identifier associated with the mobile device to be paged.

20. The method of claim 18, wherein the wireless network comprises at least one cell, said at least one cell being configured to receive the paging request generated by the processing circuitry, the method further comprising the step of wirelessly broadcasting the paging request via an antenna of the network to enable said at least one cell to wirelessly communicate with the mobile device being paged.

21. The method of claim 18, wherein said technological capability includes a wireless protocol technology that said at least one cell utilizes to wirelessly broadcast paging requests to mobile devices that have the technological capability to wirelessly communicate using said wireless protocol technology.

22. The method of claim 18, wherein said technological capability corresponds to a band class over which said at least one cell is configured to wirelessly broadcast paging requests and over which the mobile device being paged is configured to wirelessly communicate.

23. The method of claim 18, wherein said technological capability corresponds to one or more specific channels over which the mobile device being paged is capable of communicating and over which said at least one cell is capable of communicating with mobile device.

24. The method of claim 18, wherein the processing circuitry is comprised at a Mobile Switching Center (MSC) of the wireless network, and wherein the technological capability of the mobile device is stored at the MSC of the wireless network.

25. The method of claim 24, wherein the MSC is the home MSC of the mobile device.

26. The method of claim 25, wherein the technological capability of the mobile device is stored in a Home Location Register (HLR) of the home MSC.

27. The method of claim 26, wherein the technological capability of the mobile device is stored in a Visitor Location Register (VLR) of the home MSC.

28. The apparatus of claim 26, wherein when the mobile device is to be paged, the MSC generates a paging request that is broadcast only to mobile devices that have the same technological capability of the mobile device being paged.

29. The apparatus of claim 26, wherein the MSC is a serving MSC of the mobile device, and wherein the serving MSC determines when the mobile device has registered with the network comprising the serving MSC, and wherein the serving MSC obtains information relating to the technological capability of the mobile device from the home MSC of the mobile device, and wherein the serving MSC uses the information obtained by the MSC when generating a paging request for the mobile device that is based at least partially on the information obtained from the home MSC relating to the technological capability of the mobile device.
